(19) United States
(12) Patent Application Publication
(10) Pub. No.: US 2003/0144613 A1
(43) Pub. Date: Jul. 31, 2003

(54) Orthopedic apparatus for manipulatively stretching one's body using one's weight and method of using same

(76) Inventors: Isao Kitada, Saitama (JP); Kotaro Yamamoto, Hokkaido (JP)

Correspondence Address: WENDEROTH, LIND & PONACK, L.L.P., 2033 K STREET N. W., SUITE 800, WASHINGTON, DC, 20006-1021, US

(21) Appl. No.: 10/350,078

(22) Filed: Jan. 24, 2003

(30) Foreign Application Priority Data
Jan. 28, 2002 (JP) 2002-18449

(51) Int. Cl. A61H 1/00

(52) U.S. Cl. 601/24

(57) ABSTRACT

Disclosed is an orthopedic apparatus for effecting the manipulatively equivalent treatment of disorders of the skeletal system by using one's weight to stretch one's body. It comprises: a base having a rotary axle provided therewith; a body bearing board responsive to rotation of the rotary axle for inclining about the rotary axle, thereby raising or lowering one or the other end of the body bearing board; and a console for determining an oblique angle at which the body bearing board is inclined, selecting which direction the body bearing board is inclined, clockwise or counterclockwise, the length of time for which the body bearing board is kept inclined and determining other variables in operation. The body bearing board comprises a leg shaking section for holding the opposite legs of one's body and for shaking them horizontally, a longitudinal, parallel arrangement of rotatable rolls and a head holding section for holding the head of the patient lying on the body bearing board.

### BACKGROUND OF THE INVENTION

1. Field of the Invention

The present invention relates to an orthopedic apparatus for effecting the stretching and relaxing of one's hip for cure or prevention of lumbago, one's body for treatment of disorders of the skeletal system, and one's neck for cure of diseases caused by abnormal conditions of cervical vertebrae, and to a stretching-and-relaxing method using such an orthopedic apparatus.

2. Related Art

JP2000-237222 shows an orthopedic apparatus for cure of lumbago. It uses a body bearing board comprising three horizontal divisions each allotted to support and hold the head-and-trunk, hip and legs of a patient respectively. The hip and leg holding divisions are equipped with means for stretching the hip of the patient, and the hip holding division is additionally equipped with means for rolling the patient's body about his or her spine.

The orthopedic apparatus for cure of lumbago is so constructed that the patient's hip and legs may be forcibly stretched by pulling the hip and leg holding divisions apart from the head-and-trunk division. It is, however, difficult to control the stretching force to give a pull of the most appropriate strength. Often the patient's body may be badly loaded.

The patient is bound with belts to be fastened to the bed, and therefore, the patient's body cannot be relaxed during the treatment, accordingly lowering the treatment effect. The effect of distressing and relaxing the affected part of the patient, and of extending the bone-to-bone distance can be hardly caused.

Disadvantageously an orthopedic apparatus for neck-treatment in addition to such orthopedic apparatus for cure of lumbago need to be installed in an orthopedic hospital or osteopathy clinic, and accordingly an extra installation space is required in addition to extra investment.

In view of the above one object of the present invention is to provide an orthopedic apparatus capable of stretching one's body by giving a pleasing pull of well controlled strength while keeping the patient relaxed both in mind and body, thus causing the best treatment effect.

Another object of the present invention is to provide an orthopedic apparatus capable of effecting neck-treatment and cure of lumbago, thereby saving extra space and expense.

### SUMMARY OF THE INVENTION

To attain these objects according to the present invention an orthopedic apparatus for effecting the manipulatively equivalent treatment of disorders of the skeletal system by using one's weight to stretch one's body comprises: at least, a base having a rotary axle provided therewith; a body bearing board responsive to rotation of the rotary axle for inclining about the rotary axle, thereby raising or lowering one or the other end of the body bearing board; and a console for determining an oblique angle at which the body bearing board is inclined, selecting which direction the body bearing board is inclined, clockwise or counterclockwise, the length of time for which the body bearing board is kept inclined and determining other variables in operation, the body bearing board comprising a leg shaking section for holding the opposite legs of one's body and for shaking them horizontally, a longitudinal, parallel arrangement of rotatable rolls and a head holding section for holding the head of the patient lying on the body bearing board.

The base includes an actuator controlled by the console, an arm connected to the piston rod of the actuator for rotating the rotary axle of the base and a joint for transmitting rotation of the rotary axle to the body bearing board and for inclining the board bearing board.

The leg shaking section includes an ankle holder comprising upper and lower pinching members to pinch the ankles of the opposite legs.

One of the upper and lower members of the leg shaking section is expandable with compressed air.

The longitudinal, parallel arrangement of rotatable rolls is bendable at a selected point of its full length.

The orthopedic apparatus further includes a pole for fixing a head holder in the vicinity of the head holding section.

A method of using an orthopedic apparatus as described above comprises the steps of: laying one's body on the body bearing board with his or her opposite legs fastened by the ankle holder; raising one end of the body bearing board which is provided with the ankle holder to incline the whole body bearing board at a fixed oblique angle, thereby causing one's body to be stretched by one's weight for a predetermined length of time; raising the other end of the body bearing board which is provided with the head holding section to incline the whole body bearing board more or less relative to the horizontal line, and repeating the second and third steps several times.

The fixed oblique angle is within a range spanning from 10 to 30 degrees whereas the predetermined length of time is within a range spanning from 1 to 5 minutes.

In operation the orthopedic apparatus permits inclination of the body bearing board with its head holding section downward, making its leg shaking section shake laterally while stretching the whole body or hip of the patient with his or her weight, thus giving the patient a pleasing stretch of the most appropriate strength.

The lying patient wears fixedly a head holder, which is suspended from the pole of the head holding section, and then, the body bearing board is inclined with its leg shaking section downward, making its leg shaking section shake laterally while stretching the neck of the patient with his or her weight, thus giving the patient a pleasing stretch of the most appropriate strength.

The inclination angle can be controlled so that the stretching strength may be controlled to be most appropriate for the purpose.

The hip or neck of the patient cannot be forcibly pulled, but in the relaxed condition the hip or neck of the patient can be stretched with the well-controlled force, which is caused by the patient's weight while allowing his or her body to move on rolls when the body bearing board is inclined gradually. In this condition the muscle, fascists and joints of the patient's body and his or her mind are relaxed and loosened so that the curing effect may be multiplied by the well-controlled stretching.

Movement of the patient's body on the rolls causes the manipulative treatment by finger pressure, thereby causing the back of the patient to be relaxed still more.

Advantageously the orthopedic apparatus can be used in common for curing the affected parts of the hip and whole body and for curing the affected part of the head of the patient, thus saving the floor space, which otherwise, would be occupied by the orthopedic apparatus for exclusive use for curing the affected part of the head of the patient.

The relaxing and well-controlled stretching of the patient is repeated until the tension both in the body and mind of the patient has been completely removed, and then the bone-to-bone distance has been expanded more or less as is caused by massage.

Other objects and advantages of the present invention will be understood from the following description of orthopedic apparatuses according to preferred embodiments of the present invention, which are shown in accompanying drawing.

### BRIEF DESCRIPTION OF THE DRAWING

FIG. 1 is a perspective view of an orthopedic apparatus according to one preferred embodiment of the present invention;

FIG. 2 is a similar perspective view, but showing the orthopedic apparatus when inclined;

FIG. 3 illustrates the inner structure of the orthopedic apparatus;

FIG. 4 is a plane view of the orthopedic apparatus;

FIG. 5 shows, in section, the shaking mechanism;

FIG. 6 illustrates the shaking mechanism;

FIG. 7 illustrates another example of longitudinal, parallel arrangement of rolls;

FIG. 8 illustrates how an orthopedic apparatus according to another embodiment is used;

FIG. 9 illustrates the orthopedic apparatus of FIG. 8 in stretching the hip of the patient;

FIG. 10 illustrates the orthopedic apparatus of FIG. 8 in stretching the whole body of the patient;

FIGS. 11(a), 11(b) and 11(c) illustrate the orthopedic apparatus of FIG. 8 in intermittently stretching the whole body of the patient; and

FIG. 12 illustrates the orthopedic apparatus of FIG. 8 in stretching the neck of the patient.

### DETAILED DESCRIPTION OF PREFERRED EMBODIMENT

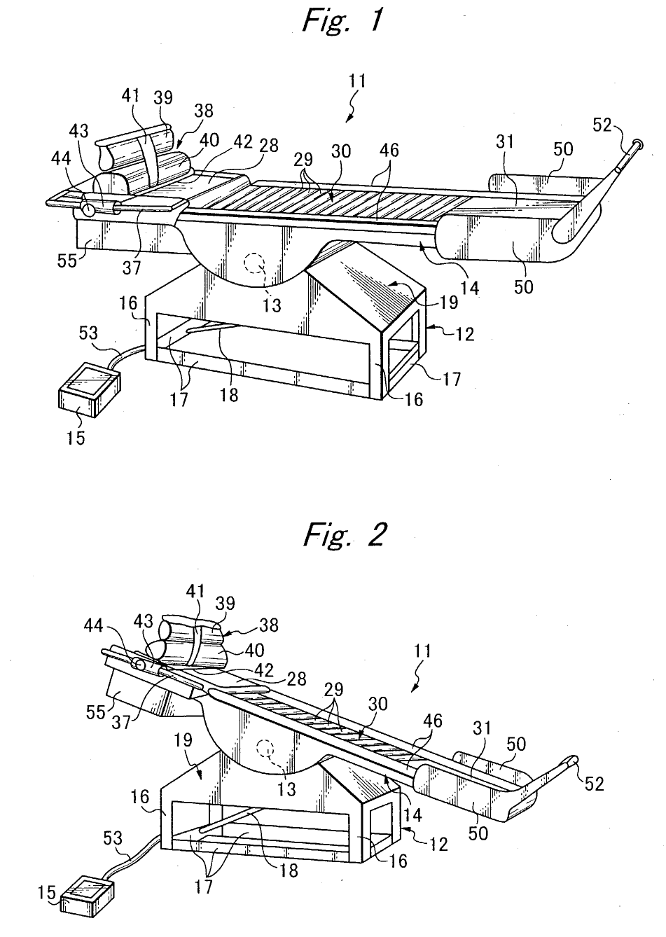

Referring to FIGS. 1 to 3, an orthopedic apparatus 11 according to the present invention can effect the manipulatively equivalent treatment of disorders of the skeletal system by using one's weight to stretch one's body. It comprises a base 12 having a rotary axle 13 provided therewith; a body bearing board 14 responsive to rotation of the rotary axle 13 for inclining about the rotary axle 13, thereby raising or lowering one or the other end of the body bearing board 14; and a console 15 for determining and setting all variables in controlling the orthopedic apparatus 11 in operation.

The base 12 comprises four steel poles 16 standing upright from its bottom corners, a frame whose four horizontal sides 17 are connected to the upright poles 16, oblique reinforcement beams 18 and an upper storage 19 built on the steel poles 16. The base 12 generally looks like a trapezoid.

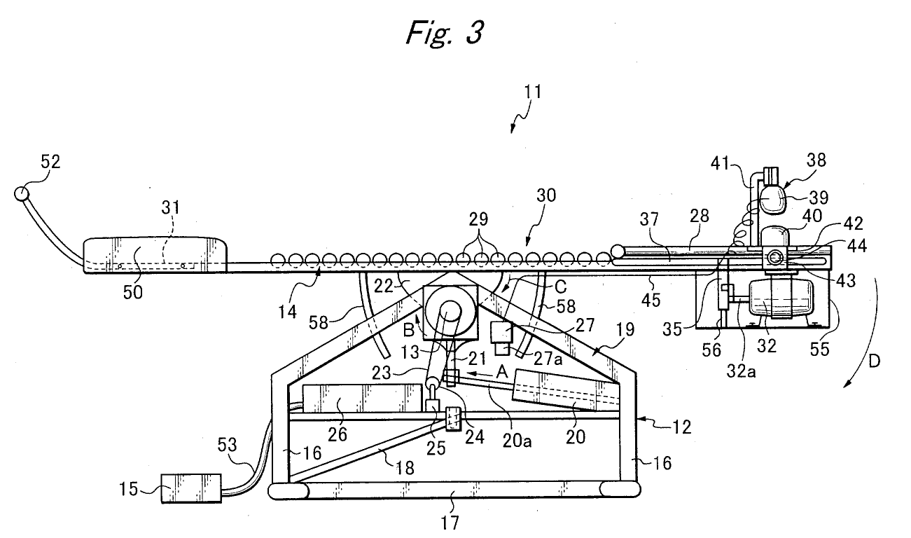

As seen from FIG. 3, the storage 19 of the base 12 includes an actuator 20 controlled by the console 15 and driven by a motor (not shown). The actuator 20 has an extendible piston rod 20a in its cylinder, and an arm 21 is connected both to the extendible piston rod 20a and to the rotary axle 13 of the base 12. The rotary axle 13 has a fan-like joint 22 integrally connected thereto, and the fan-like joint 22 is integrally connected to the bottom of the overlying body bearing board 14

With this arrangement extension of the piston rod 20a from the cylinder of the actuator 20 pushes the lower end of the arm 21 in the direction as indicated by arrow A, thereby turning the arm 21 in the clockwise direction as indicated by arrow B. Thus, the fan-like joint 22 is inclined in the clockwise direction as indicated by arrow C with the result that the body bearing board 14 is inclined in the clockwise direction as indicated by arrow D (the leg shaking end 28 being lowered).

Withdrawal of the piston rod 20a into the cylinder of the actuator 20 causes these parts to move in the directions opposite to those described above, thereby inclining the body bearing board 14 counterclockwise with the head holding end 31 lowered.

A closed loop belt 23 is stretched around the rotary axle 13 and an associated pulley 24, which is connected to a potentiometer 25 to transmit the amount of rotation from the rotary axle 13, thus converting the amount of rotation to the corresponding quantity of resistance, which is given to a PAC (sequencer) analogs inputting unit for presenting the angle of inclination of the body bearing board 14. A control circuit fixes the body bearing board at a desired inclination angle when the inclination of the body bearing board 14 has reached it.

Specifically when the console 15 sets a desired angle of inclination for the body bearing board 14, the actuator 20 is responsive to the instruction signal from the console 15 for inclining the body bearing board 14 by rotating the rotary axle 13 until the body bearing board 14 has been inclined as instructed, and then, the actuator 20 stops in response to the stop signal from the console 15. Thus, the body bearing board 14 is kept inclined at the desired angle.

A timing pulley and a tooth wheel may be used as a substitute for the closed loop belt 23, and a cam and micro-switch may be used in place of the potentiometer for controlling the angle of inclination.

In FIG. 3 the inputting units and other parts are contained in a control box 26, and a compressor 27 is used to inflate the upper expandable member 39 of an ankle holder 38, as later described. The compressor 27 is equipped with a pressure sensor 27a.

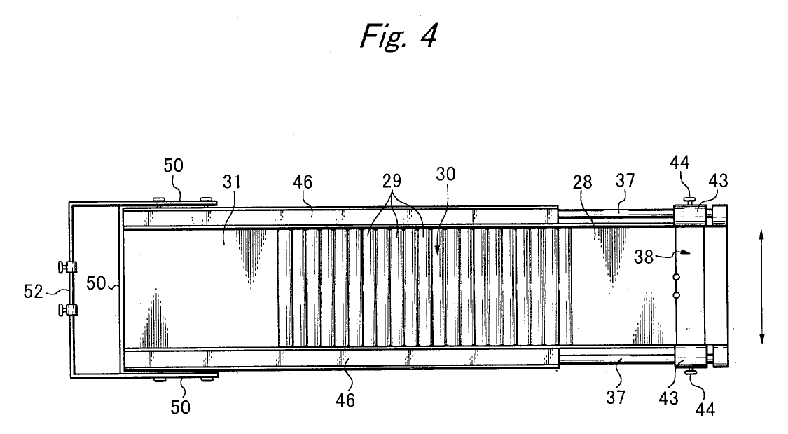

Referring to FIG. 4, the body bearing board 14 comprises a leg shaking section 28 for holding the opposite legs of one's body and for shaking them horizontally, a longitudinal, parallel arrangement 30 of rotatable rolls 29 (or roll section) and a head holding section 31 for holding the head of the patient lying on the body bearing board 14. As seen from FIG. 3, two arc guides 58 are fixed to the bottom of the body bearing board 14.

The leg shaking section 28 is like a rectangular plate, and can be moved laterally by a shaking mechanism as indicated by arrow in FIG. 4. The shaking mechanism is contained in a lower storage 55 of the leg shaking section 28 (see FIG. 3).

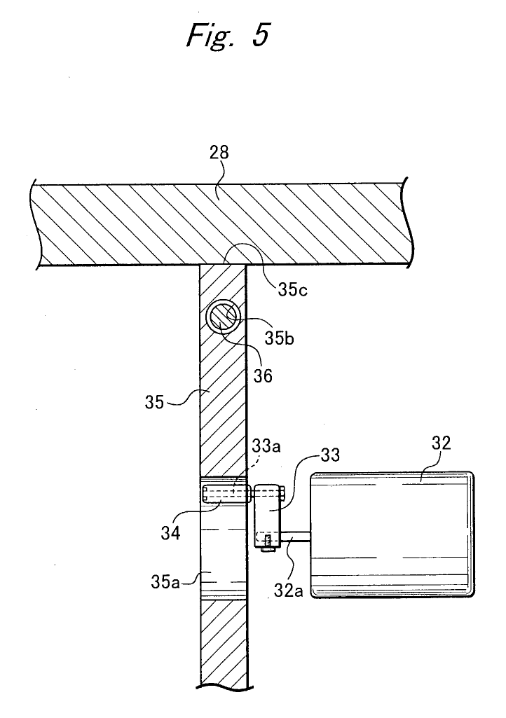

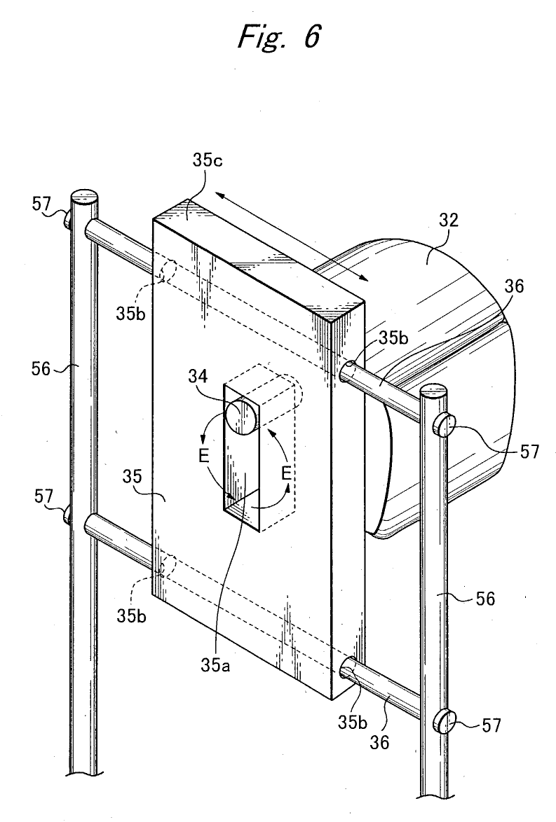

Referring to FIGS. 5 and 6, the shaking mechanism comprises a motor 32, a cam 33 fixed to the shaft 32a of the motor 32, a bearing 34 connected to the shaft 33a of the cam 33 and a shaking plate 35 having an elongated slot 35a made therein. The bearing 34 is movably inserted in the elongated slot 35a of the shaking plate 35, the upper part 35c of which is abutted and fixed to the leg shaking section 28.

The shaking plate 35 has upper and lower guide holes 35b made therein, and guide rods 36 are inserted in these guide holes 35b. The guide rods 36 are fastened to opposite vertical poles 56 with metals 57, so that they may be held horizontally. These vertical poles 56 are fixed to the bottom of the lower storage 55.

In operation the motor 32 is driven to rotate the shaft 32a, thereby rotating the cam 33 and the bearing 34 about the shaft 32a in the direction as indicated by arrow E (see FIG. 6). Accordingly the bearing 34 moves up and down in the elongated slot 35a, and at the same time, the shaking plate 35 moves laterally on the guide rods 36 so that the overlying leg shaking section 28 may move laterally in the direction as indicated by arrow in FIG. 6.

The leg shaking section 28 has pipes 37 arranged on its opposite sides, and the leg shaking section 28 has an ankle holder 38 fixed thereon. It comprises an upper cushion-like member 39, and a similar lower member 40 and a holder 41 for holding the upper and lower members 39 and 40. The ankle holder 38 has a rectangular movable plate 42 fixed to the lower part of the ankle holder 38, and the movable plate 42 has two cylinders 43 fixed to its opposite sides. The opposite pipes 37 pass through the cylinders 43. With this arrangement the ankle holder 38 can be displaced along the opposite pipes 37 until they have reached a desired position, where the ankle holder 38 can be fastened to the opposite pipes 37 by driving the screws 44 of the opposite cylinders 43.

As described earlier, the upper member 39 is connected to the air-compressor 27 via the conduit 45, and the upper member 39 can be inflated with compressed air to hold the ankles of the patient between the upper and lower members 39 and 40.

The roll section 30 comprises numerous rolls arranged in parallel, and it functions to allow the patient to slide on the rolls when the body bearing board 14 is inclined. When the patient slides on the oblique body bearing board 14, his or her back is repeatedly pressed by the summits of rolls to cause a similar effect of finger-pressure massage, thereby relaxing the back of the patient.

The head-lying section 31 and roll section 30 has two elongated mats 46 provided on it's opposite longitudinal sides (see FIG. 4).

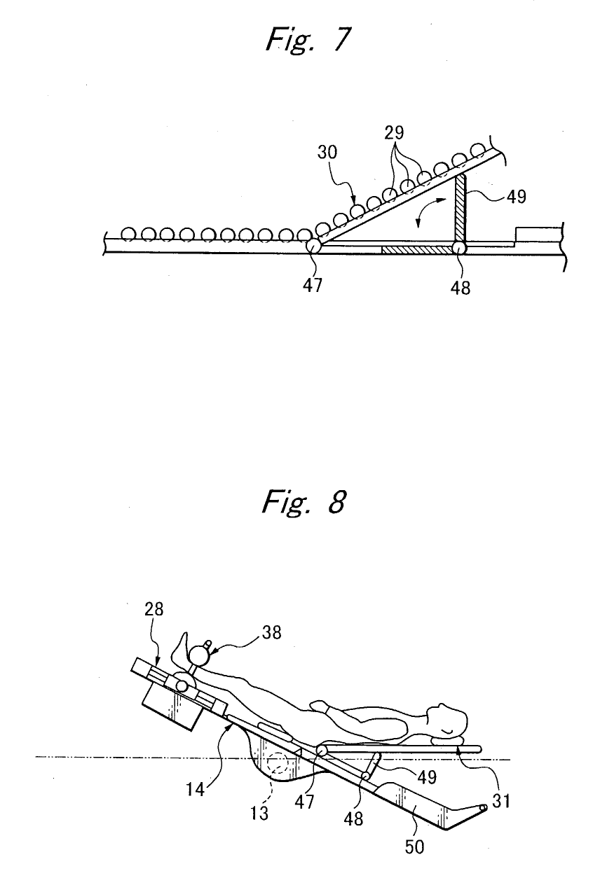

Another example of body bearing board 14 is shown in FIG. 7. The roll section 30 has a joint 47 to permit the roll section 30 to bend thereabouts, and the roll section 30 has a foldable stay 49 to fold about its joint 48. The foldable stay 49 is raised upright to keep the roll section 30 bent at an oblique angle.

Referring to FIG. 8, when the body bearing board 14 is inclined with the leg shaking end 28 raised, the head holding section 31 can be held to be horizontal by raising the foldable stay 49, thereby preventing the congestion of the patient's head which otherwise, would be caused by lowering the patient's head, and at the same time, releasing his or her mind from the unpleasant feeling caused by the expectation of danger.

The head holding section 31 is rectangular, and it's upper and opposite sides are framed with solid protecting boards 50. The head holding section 31 has a pole 52 for fixing a head holder 51.

The console 15 sends instruction signals to the control box 26 via the electric cord 53, and then the control box 26 sends control signals to the actuator 20 to effect the followings: the body bearing board is inclined in a selected direction to remain oblique at a desired angle for a predetermined length of time; the body bearing board is moved up and down intermittently at several minute-long intervals; the air-compressor 27 turns on and off; the leg-shaking section 28 shakes the legs of the patient side to side.

Specifically the mode of “hip or whole body” stretching operation is selected on the console 15, the body bearing board 15 is inclined with the head holding section lowered to stretch the hip or the whole body whereas the mode of “neck” stretching operation is selected on the console 15, the body bearing board 15 is inclined with the head holding section raised to stretch the patient's neck. The inclining angle can be selected as desired, for examples, 10, 20 or 30 degrees, and the inclining stretch of time can be selectively determined to be 1, 2 or 3 minutes long.

The console 15 is shown as being separate from the base 12 or the body bearing board 14, but it may be built in the base 12 or the body bearing board 14.

Now, the manner in which the orthopedic apparatus 11 is used is described below.

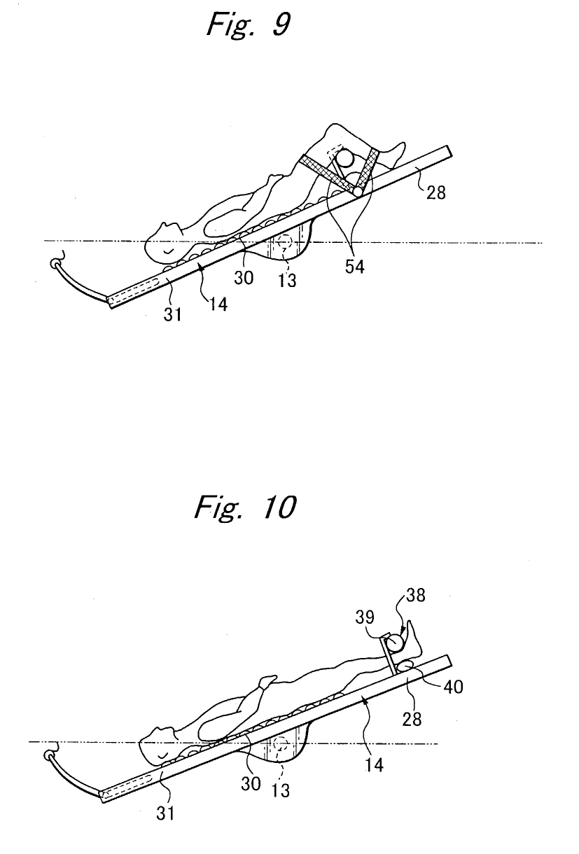

In case of stretching the patient's hip he or she is laid on the back on the body bearing board 14 with his or her legs bent about their joints and with their joints put on the raised ankle holder, as shown in FIG. 9. The ankles and thighs are bound with belts 54, and then, the body bearing board 14 is inclined to lower the head holding section 31 at an oblique angle selected in the range spanning from 10 to 30 degrees. The leg shaking section 28 is moved side to side, thereby allowing the patient to slide on the rolls 30 more or less, thereby stretching his or her hip by his or her weight.

In case of stretching the whole body the patient's ankles are pinched and held between the upper and lower members 39 and 40, and then the body bearing board 14 is inclined at an angle selected in the range spanning from 10 to 30 degrees with the head holding section 31 down (see FIG. 10), and then, the leg shaking section 28 is moved side to side, thereby relaxing not only the hip but also the whole body, and at the same time, effecting the manipulatively equivalent treatment of disorders of the skeletal system by using his or her weight.

The stretching force can be well controlled automatically thanks to use of the patient's weight, removing the stress both from the body and mind by relaxing the muscle, ligaments and joints of the whole body. Thus, the fairly good medical effect may be caused by multiplying the stretching by the relaxing effect.

Finally, the recommendable mode of body-stretching operation is described below.

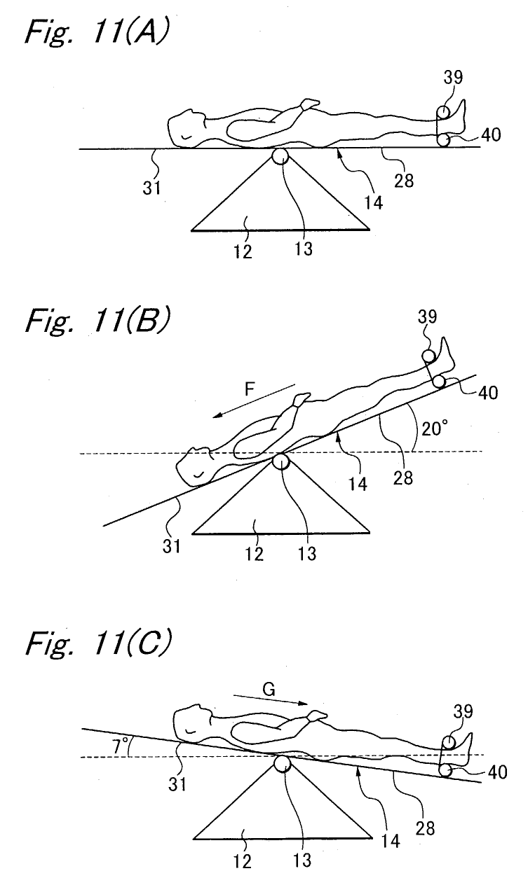

A patient is laid on the back on the body bearing board 14 with his or her ankles pinched and held between the upper and lower members 39 and 40 of the ankle holder, as shown in FIG. 11(a).

The body bearing board 14 is inclined, for example, at an angle of 20 degrees with the head holding section 31 lowered, and then the leg shaking section 28 is moved side to side. The patient slides downward on the rolls 30 more or less, thereby putting his or her body in stretching condition, as indicated by arrow F, as shown in FIG. 11(b).

The patient is kept in this position for 120 seconds, and then, the body bearing board 14 is inclined approximately at 7 degrees in the opposite direction, thus raising the head holding section 31 and lowering the leg-shaking section 28. Then, the leg-shaking section 28 stops. In this position the patient's body is displaced in the direction as indicated by arrow G so that the patient may be relaxed, as shown in FIG. 11(c).

The counterclockwise and clockwise inclinations are repeated alternately, thereby putting the patient's body in the loosing and tightening condition by using the patient's weight, thus effectively expanding the born-to-born distance.

Preferably the inclination angle at which the body bearing board is inclined with the head holding section down is in the range spanning from 10 to 30 degrees whereas the inclination angle at which the body bearing board is inclined with the head holding section up is in the range spanning from 1 to 10 degrees. The period for which the stretching continues with the head holding section 31 lowered is preferably 1 to 5 minutes long.

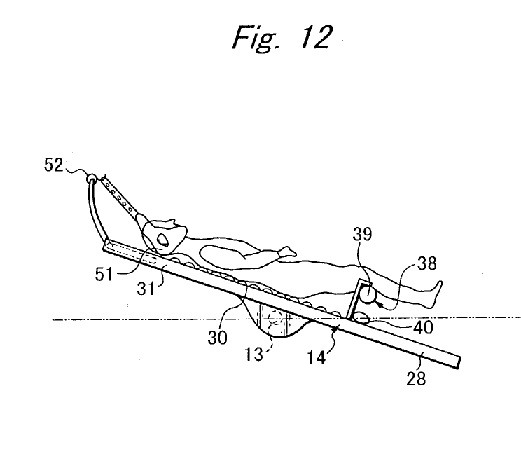

In stretching the head of the patient, the patient wears the head holder 51, and his or her legs are put on the ankle holder 38. Then, the body bearing board 14 is inclined at an oblique angle selected in the range spanning from 10 to 20 degrees with the leg-shaking section 28 down, as shown in FIG. 12. Then, the leg shaking section 28 is moved side to side. As a natural consequence the patient's body is slidably displaced in the direction in which the body bearing board 14 is inclined to stretch the patient's neck by the force, which varies with the controlled oblique angle and the patient's weight.

As may be understood from the above, use is made of the patient's weight in stretching a patient's hip or whole body by controlling the oblique angle at which the body bearing board having the patient laid on the back thereon is inclined with the head holding section lowered, and by moving the leg-holding section side to side. The stretching as required can be effected by controlling the oblique angle to provide a most appropriate stretching force.

The patient wears a head holder, and he or she is laid on the back on the body bearing board, and then, the body bearing board is inclined with the leg-shaking section down, and it is moved side to side. Thus, his or her neck can be stretched by using his or her weight in a most appropriate way.

The inclination angle is controlled to meet the required treatment of the affected part of the patient's body.

The stretching is effected moderately by controlling the oblique angle of the body bearing board, thereby loosening the muscle, cord and joints and accordingly relaxing the patient's body and mind. Thus, the best medical treatment effect may be cased by multiplying the stretching by relaxation both in body and mind.

Use of rolls gives the finger pressure-like manipulative treatment to the patient, relaxing his or her back.

The orthopedic apparatus according to the present invention can be used in common for stretching the hip and whole body and the neck of a patient, thus avoiding the necessity of installing a stretcher exclusively used for stretching a patient's neck.

The leg-shaking section is equipped with the ankle holder, which comprises upper and lower members to sandwich the patient's ankle comfortably by inflating the upper member with air.

The roll section can be bent at a predetermined position, and it uses a stay holder for keeping the roll section bent and inclined. With this arrangement the upper part of the patient's body can be held horizontally when the body bearing board is inclined with the leg-shaking section raised, thus preventing the congestion which otherwise, would be caused in the patient's head.

Alternately repeated are the inclination of the body bearing board with the leg-shaking section up to stretch the whole body by the patient's weight, followed by continuance of stretching in such position for a certain fixed stretch of time, and the counter slight inclination of the body bearing board with the head holding section up. This alternative inclination of the body bearing board is effective in relaxing the body and mind of the patient, and at the same time, in expanding the bone-to-bone distance like the massage effect.

What is claimed is:

1. An orthopedic apparatus for effecting the manipulatively equivalent treatment of disorders of the skeletal system by using one's weight to stretch one's body comprising: at least, a base having a rotary axle provided therewith; a body bearing board responsive to rotation of the rotary axle for inclining about the rotary axle, thereby raising or lowering one or the other end of the body bearing board; and a console for determining an oblique angle at which the body bearing board is inclined, selecting which direction the body bearing board is inclined, clockwise or counterclockwise, the length of time for which the body bearing board is kept inclined and determining other variables in operation, the body bearing board comprising a leg shaking section for holding the opposite legs of one's body and for shaking them horizontally, a longitudinal, parallel arrangement of rotatable rolls and a head holding section for holding the head of the patient lying on the body bearing board.

2. An orthopedic apparatus according to claim 1, wherein the base includes an actuator controlled by the console, an arm connected to the axle of the actuator for rotating the rotary axle of the base and a joint for transmitting rotation of the rotary axle to the body bearing board and for inclining the bearing board.

3. An orthopedic apparatus according to claim 1, wherein the leg shaking section includes an ankle holder comprising upper and lower pinching members to pinch the ankles of the opposite legs.

4. An orthopedic apparatus according to claim 3, wherein one of the upper and lower members of the leg shaking section is expandable with compressed air.

5. An orthopedic apparatus according to claim 1, wherein the longitudinal, parallel arrangement of rotatable rolls is bendable at a selected point of its full length and it includes a stay to keep the bent section of the rolls at an oblique angle.

6. An orthopedic apparatus according to claim 1, wherein it further includes a pole for fixing a head holder in the vicinity of the head holding section.

7. A method of using an orthopedic apparatus as described in claim 1 comprising the steps of:
laying one's body on the body bearing board with his or her opposite legs fastened by the ankle holder;
raising one end of the body bearing board which is provided with the ankle holder to incline the whole body bearing board at a fixed oblique angle, thereby causing one's body to be stretched by one's weight for a predetermined length of time;
raising the other end of the body bearing board which is provided with the head holding section to incline the whole body bearing board more or less relative to the horizontal line, and
repeating the second and third steps several times.

8. A method according to claim 7, wherein the fixed oblique angle is within a range spanning from 10 to 30 degrees whereas the predetermined length of time is within a range spanning from 1 to 5 minutes.
